(19) United States
(12) Patent Application Publication
(10) Pub. No.: US 2005/0136180 A1
(43) Pub. Date: Jun. 23, 2005

(54) Method of coating a substrate with a fluoropolymer

(75) Inventors: Mark J. Pellerite, Woodbury, MN (US); Steven J. Martin, Shoreview, MN (US); Rudolf J. Dams, Antwerp (BE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/741,357

(22) Filed: Dec. 19, 2003

(51) Int. Cl. B05D 5/00

(52) U.S. Cl. 427/162; 427/258; 427/430.1

(57) ABSTRACT

A method for coating a substrate comprises: coating at least a portion of the substrate with a precursor composition comprising a liquid vehicle and at least one fluorinated organosilane; and contacting at least a portion of the coated substrate with a catalyst composition to provide a substrate having a crosslinked fluoropolymeric coating on at least a portion thereof.

### BACKGROUND

Many optical elements and electronic displays are prone to scratching and contamination. These are especially common and troublesome problems for substrates (e.g., ophthalmic lenses) that have a multilayer anti-reflective (AR) coating. Typically, the outermost layer of such coatings consists of silica or a metal oxide, or a metal halide (e.g., MgF₂). Typically, such AR coatings are not only easily scratched, but the optical performance may also be compromised by contaminants such as, for example, skin oils, beauty creams and lotions, and other oil based materials.

To help protect against such damage, protective polymeric coatings are commonly applied to uncoated and AR coated substrates after they are fabricated, but before they are put into service. The protective coating helps guard against scratching and contamination of the AR coating by ubiquitous contaminants such as, for example, skin oils, that can compromise the anti-reflective properties of the AR coating.

Often, such protective coatings are applied to a substrate as a reactive precursor solution that subsequently forms a permanent coating, for example, on evaporation and/or heating. However, such processes often require anywhere from 15 minutes up to several hours to complete, and may require special ovens and/or curing chambers. Further, reactive precursor solutions may be prone to premature curing that leads to shelf-life problems.

### SUMMARY

In one aspect, the present invention provides a method for coating a substrate comprising:
coating at least a portion of a substrate with a precursor composition to form a coated substrate, wherein the precursor composition comprises a liquid vehicle and at least one fluorinated organosilane having the formula
   R_{f}O—W—R³-Q
   or
   Q-R³—OW—R³-Q
   wherein
W represents a divalent perfluoropolyether segment comprising at least 5 monomer units selected from the group consisting of —CF₂O—, —CF₂CF₂O—, —CF(CF₃)CF₂—, —OCF(CF₃)CF₂—, —CF₂CF₂CF₂O—, —CF₂CF₂CF₂CF₂O—, and combinations thereof;
R_{f} is a perfluoroalkyl group having from 1 to 8 carbon atoms;
Q independently represents -Z-R¹—SiY₍₃₋ₓ₎R²ₓ;
wherein
   Z independently represents a covalent bond, a carbonyloxy group, a carbonylthio group, a carbonylamino group, a carbonylamino group, an alkyleneoxycarbonyl group having from 2 to 7 carbon atoms, an alkylenaminocarbonyl group having from 2 to 7 carbon atoms, an alkyleneoxycarbonylamino group having from 2 to 7 carbon atoms, an alkylenoxy group having from 1 to 6 carbon atoms, or an alkyleneaminocarbonyloxy group having from 2 to 7 carbon atoms;
   R¹ independently represents a divalent linear or branched alkylene or alkylenoxyalkylene group having from 1 to 6 carbon atoms;
   R² independently represents an alkyl group having from 1 to 4 carbon atoms;
   Y independently represents halogen, an alkoxy group having from 1 to 4 carbon atoms, or an acyloxy group having from 1 to 4 carbon atoms;
   x independently represents 0 or 1; and
R³ independently represents —CF₂—, —CF(CF₃)—, —CF₂CF₂—, or —CF₂CF₂CF₂—; and
contacting at least a portion of the coated substrate with a catalyst composition comprising at least one strong acid and having a pH of less than or equal to 3 to provide a substrate having a crosslinked fluoropolymeric coating on at least a portion thereof. In one embodiment, the substrate may be an ophthalmic lens.

In another embodiment, the method may be used for applying a protective coating to a substrate having an AR coating thereon, wherein the protective coating does not interfere with the anti-reflective properties of the AR coating.

Typically, the method of the present invention is relatively easy and quick to perform, may be carried out at slightly elevated, ambient, or even sub-ambient temperatures, and is not prone to shelf-life problems. Further, in some embodiments the method is suitable for use in open air environments such as may be found, for example, on a countertop in a lens fabricating facility or retail store.

As used herein,
“strong acid” refers to any Brønsted acid that has a pKₐ of less than or equal to 2 in water at 25° C.;
“weak acid” refers to any Brønsted acid that has a pKₐ of greater than 2 in water at 25° C.; and
“Brønsted acid” refers to a molecular entity capable of donating a proton to a base.

### DETAILED DESCRIPTION

Suitable substrates that may be provided with a protective coating according to the present invention include any solid substrate. For example, the substrate may comprise ceramic, plastic, glass, quartz, metal, fabric, wood, or a combination thereof. Typically, the present invention is best practiced with substrates having at least one surface with reactive groups such as, for example, hydroxyl or amino groups that can form a bond with the silicon atom of the fluorinated organosilane. Examples of such substrates include ceramics, silicon, glass, quartz, metal, and substrates (including thermoplastic substrates) that have an antireflective coating thereon, especially if the outermost layer of the antireflective coating is a layer that comprises metal oxide.

The substrate may have a primed or chemically modified surface. Examples of techniques for modifying the surface of a substrate include chemical etching, electron beam irradiation, corona treatment, and plasma etching.

The substrate may comprise at least one thermoplastic material. Examples of suitable thermoplastic materials include polyacrylates, polymethacrylates (e.g., poly(methyl methacrylate)), polystyrene, styrenic copolymers (e.g., acrylonitrile-butadiene-styrene copolymers and acrylonitrile-styrene copolymers), cellulose esters (e.g., cellulose acetate and cellulose acetate-butyrate copolymers), polyvinyl chloride, polyolefins (e.g., polyethylene and polypropylene), polycarbonates, polyimides, polyphenylene oxide, polyesters (e.g., polyethylene terephthalate and polyethylene naphthalate), polyurethanes, polythiourethanes, and combinations thereof.

In one particularly useful embodiment, the substrate may be an ophthalmic lens, optionally having an AR coating on at least a portion thereof.

The term “ophthalmic lens” as used herein refers to any lens (tinted, coated, or otherwise) through which light is transmitted into a human eye during ordinary use. Examples of ophthalmic lenses include eyeglass lenses (including spectacle and monacle lenses), binocular lenses, and telescope lenses (e.g., eyepieces).

As used herein, the term “antireflective coating” refers to at least one layer of a dielectric material having an index of refraction that is lower than the index of refraction of the material supporting the coating. If present, the optional antireflective coating is typically disposed on at least one major surface of the ophthalmic lens, and is capable of at least partially transmitting one or more wavelengths of visible electromagnetic radiation.

Antireflective coating layers can be prepared from dielectric materials such as, for example, metal oxides, metal sulfides (e.g., zinc sulfide), metal halides (e.g., magnesium fluoride), metal nitrides (e.g., nitrides of silicon, titanium, zinc, zirconium, hafnium, vanadium, and niobium), and combinations thereof.

In some embodiments, antireflective coating layers are prepared from metal oxides. As used herein, the term “metal oxide” refers to an oxide of a single metal (including metalloids) or to an oxide of a metal alloy. Suitable metal oxides for one or more layers of an antireflective coating include oxides of tin, titanium, niobium, zinc, zirconium, tantalum, yttrium, aluminum, cerium, tungsten, bismuth, indium, silicon, and combinations thereof. Examples include SnO₂, TiO₂, Nb₂O₅, ZnO, ZrO₂, Ta₂O₅, Y₂O₃, Al₂O₃, CeO₂, WO₃, Bi₂O₅, In₂O₃, and indium tin oxide. In some embodiments, the antireflective coating can be a single layer of a silicon oxide or can include an outer layer of a silicon oxide. The silicon oxide may be depleted of oxygen (i.e., the amount of oxygen in the metal oxide is less than the stoichometric amount). For example, the outer surface can include SiO_{z} where z is no greater than two.

Antireflective coatings may be deposited by thermal evaporation, sputtering techniques, or other vacuum deposition methods. In some applications, metal oxide films formed by sputtering techniques are preferred over metal oxide films formed by thermal evaporation techniques. Sputter coated antireflective coatings tend to have higher densities and to be harder, smoother, and more durable than thermally evaporated coatings. Although such sputtered coatings tend to be relatively porous and consist of clusters of particles with diameters of about 5 to about 30 nanometers as measured by atomic force microscopy, the coatings are usually sufficiently impermeable to water and gases that can alter their mechanical, electrical, and optical properties.

Further details concerning suitable antireflective coatings and methods for making them may be found in, for example, PCT International Publication No. WO 96/31343 (Southwall Technologies Inc.) and U.S. Pat. No. 5,091,244 (Bjornard); U.S. Pat. No. 5,105,310 (Dickey); U.S. Pat. No. 5,147,125 (Austin); U.S. Pat. No. 5,270,858 (Dickey); U.S. Pat. No. 5,372,874 (Dickey et al.); U.S. Pat. No. 5,407,733 (Dickey); U.S. Pat. No. 5,450,238 (Bjornard et al.); U.S. Pat. No. 5,579,162 (Bjornard et al.); the disclosures of which U.S. patents are incorporated herein by reference.

In some embodiments, the antireflective coating may comprise an antireflective stack that includes multiple layers of dielectric materials. For example, such a stack may contain up to about 11, up to about 9, up to about 7, up to about 5, or up to about 3 antireflective coating layers. Antireflective film stacks may be obtained commercially, for example, from Viratec Thin Films, Faribault, Minn.

In order to provide chemical bonding of the protective coating to the substrate, at least a portion of the outer surface of the substrate may have functional groups that are capable of forming a covalent bond with at least one silane group of the fluorinated organosilane in the precursor composition, although this is not a requirement. Such functional groups may be provided, for example, by hydroxyl groups, sulfhydryl groups, amino groups, or by metal oxides.

The substrate may be cleaned prior to coating the precursor composition, for example, depending on its cleanliness. Suitable methods for cleaning may include, for example, plasma treatment, corona treatment, solvent rinsing, and detergent rinsing.

The precursor composition comprises a liquid vehicle and at least one fluorinated organosilane having the formula
R_{f}O—W—R³-Q
or
Q-R³—OW—R³-Q

W represents a divalent perfluoropolyether segment comprising at least 5 monomer units selected from the group consisting of —CF₂O—, —CF₂CF₂O—, —CF(CF₃)CF₂O—, —OCF(CF₃)CF₂—, —CF₂CF₂CF₂O—, and —CF₂CF₂CF₂CF₂O—. Each monomeric unit may appear in any order and any number of times. Examples of divalent perfluoropolyether segments include —(CF₂O)₄CF₂CF₂—, —CF₂O(CF₂CF₂O)₃CF₂O—, —CF₂O—CF₂CF₂O—CF(CF₃)CF₂O—(CF₂CF₂CF₂O)₂—, —CF₂O—CF₂CF₂O—(CF(CF₃)CF₂O)₃—, and —(CF₂O)ₖ—, —(CF₂CF₂O)ₖ—, —(CF(CF₃)CF₂O)ₖ—, and —(CF₂CF₂CF₂CF₂O)ₖ—, wherein k is an integer greater than or equal to 5.

R_{f} is a perfluoroalkyl group having from 1 to 8 carbon atoms. R_{f} may be branched or linear. For example, R_{f} may be trifluoromethyl, pentafluoroethyl, heptafluoropropyl, perfluorobutyl, perfluoro(2-methylbutyl) or perfluorooctyl.

R³ independently represents —CF₂—, —CF(CF₃)—, —CF₂CF₂—, or —CF₂CF₂CF₂—.

Q independently represents a group having the formula
-Z-R¹—SiY₍₃₋ₓ₎R²ₓ
wherein
Z independently represents a covalent bond, carbonyloxy group, a carbonylthio group, a carbonylamino group, a carbonylimino group, an alkylenoxycarbonyl group having from 2 to 7 carbon atoms (e.g., ethylenoxycarbonyl, isopropylenoxycarbonyl, hexylenoxycarbonyl), an alkylenaminocarbonyl group having from 2 to 7 carbon atoms (e.g., ethylenaminocarbonyl, isopropylenaminocarbonyl, hexylenaminocarbonyl), an alkyleneoxycarbonylamino group having 2 to 7 carbon atoms (e.g., ethylenoxycarbonylamino, propylenoxycarbonylamino, isobutylenoxycarbonylamino, hexylenoxycarbonyl), an alkyleneoxy group of 1 to 6 carbon atoms (e.g., ethylenoxy, isopropylenoxy, hexylenoxy), or an alkyleneaminocarbonyloxy group having from 2 to 7 carbon atoms (e.g., ethylenaminocarbonyloxy, isopropylenaminocarbonyloxy, hexylenaminocarbonyloxy);
R¹ independently represents a divalent linear or branched alkylene or alkylenoxyalkylene group having from 1 to 6 carbon atoms such as, for example, methylene, ethylene, propylene, isobutylene, hexylene, or methyleneoxypropylene;
R² independently represents an alkyl group having from 1 to 4 carbon atoms such as, for example, methyl, ethyl, or butyl;
Y independently represents halogen; an alkoxy group having from 1 to 4 carbon atoms such as, for example, methyl, ethyl, or butyl; or Y is an acyloxy group having from 2 to 4 carbon atoms such as, for example, acetoxy, propionyloxy, or butanoyloxy; and
x independently represents 0 or 1.

Useful fluorinated organosilanes typically have a molecular weight (number average) of at least about 400 g/mole, for example, they may have a number average molecular weight of at least about 500, at least about 750, or even at least about 1000 g/mole up to 10,000 g/mole or more. These precursors are described further in U.S. Pat. No. 6,277,485 (Invie, et al.), the disclosure of which is incorporated herein by reference.

Examples of useful fluorinated organosilanes having a single silyl group include C₃F₇O(CF(CF₃)CF₂O)ₚCF(CF₃)C(O)NH(CH₂)₃Si(OCH₃)₃, C₃F₇O(CF(CF₃)CF₂O)ₚCF(CF₃)C(O)NH(CH₂)₃Si(OC₂H₅)₃, C₃F₇O(CF(CF₃)CF₂O)ₚCF(CF₃)C(O)NH(CH₂)₃SiCH₃(OCH₃)₂, C₃F₇O(CF(CF₃)CF₂O)ₚCF(CF₃)C(O)NH(CH₂)₃SiCH₃(OC₂H₅)₂, CF₃O(C₂F₄O)ₚCF₂C(O)NH(CH₂)₃Si(OCH₃)₃, CF₃O(C₂F₄O)ₚCF₂C(O)NH(CH₂)₃Si(OC₂H₅)₃, CF₃O(C₂F₄O)ₚCF₂C(O)NH(CH₂)₃SiCH₃(OCH₃)₂, and CF₃O(C₂F₄O)ₚCF₂C(O)NH(CH₂)₃SiCH₃(OC₂H₅)₂ wherein p is in a range of from 4 to 40, inclusive.

Examples of fluorinated organosilanes having two silyl groups include Q¹-CF₂O(CF₂O)ₘ(C₂F₄O)_{q}CF₂-Q¹, Q¹-CF(CF₃)(OCF₂CF(CF₃))ₘO(CₙF₂ₙ)O(CF(CF₃)CF₂O)_{q}CF(CF₃)-Q¹, Q¹-CF₂O(C₂F₄O)_{q}CF₂-Q¹, and Q¹-(CF₂)₃O(C₄F₈O)_{q}(CF₂)₃-Q¹ where m is an integer of 0 to about 50, n is an integer of 2 to 4, q is an integer of 0 to about 50, wherein both m and q are not equal to 0. Q¹ is selected from —CONH(CH₂)₃Si(OCH₃)₃, —CONH(CH₂)₃Si(OC₂H₅)₃, —CONH(CH₂)₃SiCH₃(OCH₃)₂, —CONH(CH₂)₃SiCH₃(OC₂H₅)₂, and combinations thereof.

In one embodiment, the fluorinated organosilane may be a compound having the formula X—CF₂O(CF₂O)ₘ(C₂F₄O)_{q}CF₂—X wherein m and q are independently integers in a range of from 5, 8, or even 9 up to 10, 11, 12, or even 15, and each X is independently selected from —CONH(CH₂)₃Si(OCH₃)₃, —CONH(CH₂)₃Si(OC₂H₅)₃, —CONH(CH₂)₃SiCH₃(OCH₃)₂, and —CONH(CH₂)₃SiCH₃(OC₂H₅)₂. For example, the fluorinated organosilane may be (H₃CO)₃Si(CH₂)₃NHCOCF₂O(CF₂O)ₘ(C₂F₄O)_{q}CF₂CONH(CH₂)₃Si(OCH₃)₃, wherein both m and q are independently integers in a range of from 8 or 9 up to 10 or 12.

Typically, fluorinated polyethers and fluorinated organosilanes are obtained as complex mixtures having species with different numbers of repeating monomer units. Such mixtures are commonly referred to in the art as having an average structure that represents a number average of all the species taken together. In such cases, the subscripts that reflect the number of repeat units in the perfluoropolyether segment are often written as a non-integer (e.g., 5.1 or 7.8) even though the component molecules have integral subscript values.

Fluorinated organosilanes of the types listed above can be synthesized using conventional techniques. For example, commercially available or readily synthesized perfluoropolyether esters (or functionalized derivative thereof) can be combined with a functionalized alkoxysilane such as, for example, a 3-aminopropylalkoxysilane, generally according to the method of U.S. Pat. No. 3,810,874 (Mitsch et al.), the disclosure of which is incorporated herein by reference. It will be understood that functional groups other than esters may be used with equal facility to attach silane group(s) to a perfluoropolyether.

In accordance with a particular embodiment of the present invention, perfluoropolyether esters may be prepared through direct fluorination of a hydrocarbon polyether diester. Direct fluorination involves contacting the hydrocarbon polyether diester with F₂. Accordingly, the hydrogen atoms on the hydrocarbon polyether diester will be replaced with fluorine atoms thereby generally resulting in the corresponding perfluoropolyether diester. Direct fluorination methods are disclosed in, for example, U.S. Pat. No. 5,578,278 (Fall et al.) and U.S. Pat. No. 5,658,962 (Moore et al.), the disclosures of which are incorporated herein by reference.

The liquid vehicle may be any solvent or solvent mixture that is capable of at least partially dissolving the fluorinated organosilane. Suitable solvents are substantially unreactive with the fluorinated organosilane under ambient conditions (e.g., aprotic), and are capable of dissolving the fluorinated organosilane. Examples of suitable solvents include alcohols (e.g., ethanol and isopropanol), ketones (e.g., acetone and methyl ethyl ketone), esters (e.g., ethyl acetate), hydrocarbons (e.g., alkanes such as heptane, decane, or paraffinic solvents), fluorinated hydrocarbons (e.g., fluorine substituted alkanes, fluorine substituted ethers, and hydrofluoroethers), hydrochlorofluoroalkanes and ethers, and combinations thereof.

Examples of hydrofluoroethers are described in U.S. Pat. No. 6,274,543 B1 (Milbrath et al.), the disclosure of which is incorporated herein by reference. For example, the alkyl perfluoroalkyl ether can be methyl perfluorobutyl ether (e.g., as marketed under the trade designation “3M NOVEC ENGINEERED FLUID HFE-7100” by 3M Company, St. Paul, Minn.), or ethyl perfluorobutyl ether (e.g., as marketed under the trade designation “3M NOVEC ENGINEERED FLUID HFE-7200” by 3M Company).

The precursor composition may also contain various additives. Exemplary additives include curatives and other silanes (e.g., tetraethylorthosilicate).

To reduce shelf-life concerns, additives may be selected such that they do not react with the fluorinated silane or fluorinated siloxane precursors in the precursor composition at ambient temperatures.

Typically, the precursor composition may be prepared by simply diluting the fluorinated organosilane to a desired viscosity by adding an appropriate amount of the liquid vehicle with mixing. The desired viscosity may be dictated, for example, by the coating method chosen for applying the precursor composition to the substrate.

The precursor composition may be applied to the treated article by a variety of techniques. Suitable application techniques include spraying, casting, rolling, spin coating, dip coating, or immersing. The precursor composition can be applied (e.g., as a continuous or discontinuous coating) to all surfaces, selected surfaces (e.g., major surfaces), or portions of selected surfaces of the substrate. Using dip coating, coating thickness may typically be adjusted by varying the withdrawal rate of the lens from the precursor solution as well as the precursor concentration. For example, for typical precursor compositions, useful coating weights of fluorinated silanes are typically obtained using withdrawal rates of at least 5, 10, or even 20 millimeters per minute under ambient conditions.

After applying the precursor composition to the substrate, and optionally removing at least a portion of the liquid vehicle (e.g., by evaporation), the overall thickness of the resultant coating on the substrate is typically at least 1.2 nanometers or the approximate thickness of a monolayer of the fluorinated organosilane. In some applications, the coating may have a thickness of less than 50, 20, 15, 10, 5, or even 3 nanometers. The thickness is generally selected so that the antireflective characteristics of any optional antireflective coating that may be present are not adversely affected. For example, when the precursor composition is applied to only a portion of the antireflective coating of the treated article, the boundary between coated and uncoated areas is typically only barely discernible to the naked eye. To adequately balance performance with respect to antisoiling, durability, and anti-reflectance, the thickness of the precursor composition after removal of the liquid vehicle may be in a range of from 4 nanometers to 15 nanometers.

The precursor composition typically contains less than 5 weight percent, for example, less than 5, 1, 0.5, or even less than about 0.3 weight percent of the fluorinated organosilane based on the total weight of the precursor composition.

Once applied to the substrate, the precursor composition (typically with at least some of the liquid vehicle removed) is contacted with a catalyst composition to facilitate hydrolysis, condensation, and crosslinking of the fluorinated organosilane.

The catalyst composition comprises at least one strong acid. While the strong acid has a pH of less than 2, it may, for example, have a pKₐ in water at 25° C. of less than or equal to that of nitric acid, sulfuric acid, hydrochloric acid, perchloric acid, hydriodic acid, or hydrobromic acid. To ensure sufficient acidic strength, the pH of the catalyst composition should be less than or equal to 3 (e.g., less than or equal to 2, 1 or even less than 0). Examples of suitable acids that may be included in the catalyst composition include mineral acids such as sulfuric acid, nitric acid, perchloric acid, hydrochloric acid, hydrobromic acid; sulfonic acids such as p-toluenesulfonic acid, and trifluoromethanesulfonic acid; and combinations thereof.

Typically, pH may be readily determined by various well-known techniques including, for example, pH paper, pH meters, and acid indicators.

Values of pKₐ for many inorganic and organic acids are tabulated in various standard reference works such as, for example, J. A. Dean in “Lange's Handbook of Chemistry”, Fifteenth Edition, 1999, McGraw-Hill, New York, pages 8.16-8.72, and the “Dictionary of Inorganic Compounds”, Chapman & Hall; New York, 1992. Alternatively, the value of pKₐ may be determined by well-known experimental methods. In the case of compounds having a pKₐ value of less than 0, it may be difficult to precisely obtain a value of pKₐ in water, however an upper limit to acidity of for example, less than 1 or less than 0 can generally be determined.

The catalyst composition typically comprises water, one or more organic solvents, or a combination thereof. Examples of suitable organic solvents include ethers, ketones, alcohols, esters, amides, alkanes, halogenated derivatives of the foregoing, and combinations thereof.

The catalyst composition may be brought into contact with the coating containing fluorinated organosilane by any conventional method for coating liquid materials. Examples include wiping, brushing, spraying, dip coating, and immersing.

To further facilitate hydrolysis, condensation, and crosslinking of the fluorinated organosilane, evaporation of the liquid vehicle, and/or for some other purpose, thermal energy (e.g., heat or infrared radiation) may optionally be applied to the substrate (e.g., before or after coating with the precursor composition or the catalyst composition), although this is generally not necessary.

After contacting the fluorinated silane coating with the catalyst composition, excess liquid may be removed by impingement with air or nitrogen, or rinsing with water, organic solvent, or a combination thereof. In the case of catalyst compositions wherein the acid consists of hydrochloric acid, mere evaporation is typically sufficient to remove any excess of residual acid solution.

The method of the present invention can be used, for example, by lens manufacturers to protect antireflective tinted lenses used in sunglasses, and by retail lens shops to protect new prescription ophthalmic lenses before subsequently mounting them in an eyeglass frame.

Features and advantages of this invention are further illustrated by the following non-limiting examples, but the particular materials and amounts thereof recited in these examples, as well as other conditions and details, should not be construed to unduly limit this invention.

### EXAMPLES

Unless otherwise noted, all reagents used in the examples were obtained, or are available, from general chemical suppliers such as, for example, Sigma-Aldrich Company, Saint Louis, Mo., or may be synthesized by conventional methods.

In the Tables, “NM” means not measured, and “NA” means not applicable.

In the following examples, the pH of 1N p-toluenesulfonic acid was determined experimentally using pH paper, while pH values for HCl, HBr, and HNO₃ solutions were calculated or obtained from “The Merck Index”, Tenth Edition, Merck & Co., Rahway, N.J., 1983.

Coating Thickness Test

An ellipsometer obtained under the trade designation “GAERTNER L116A SINGLE-WAVELENGTH ELLIPSOMETER” (available from Gaertner Scientific Corporation, Skokie, Ill.), operated at a wavelength of 632.8 nanometers and using a 70° incident angle, was used to measure the ellipsometric parameters psi and delta at four spots before coating and after coating with a fluorinated organosilane, and again after subsequent treatment with a catalyst composition and rinsing, where utilized. Film thicknesses were calculated from these values using software supplied with the instrument, using a three-layer model (air/film/substrate) and assuming a refractive index (n_{f}) value of 1.34 for the fluorochemical film.

Contact Angle Test

Static contact angles were determined using a contact angle analyzer obtained under the trade designation “KRUSS DROP SHAPE ANALYSIS SYSTEM, MODEL DSA10” from Kruss USA, Charlotte, N.C. using a 4-microliter drop of water.

Dry Rub Test

Ophthalmic lenses were tested for abrasion resistance using a back-and-forth motion on a linear abrader having a 0.25-inch (6.3 millimeters) diameter vertical rod that was covered with a pad consisting of 24 layers of cheesecloth fabric. The initial static contact angle of the lens (coated or otherwise as indicated) was measured according to the Contact Angle Test. The lens was then placed onto a horizontal surface with the convex surface facing upwards and the cheesecloth pad was placed onto the convex surface of the lens. The vertical rod was freely movable in the vertical direction to allow for curvature in the lens. During abrasion resistance testing, the vertical rod was moved in a repeated horizontal back and forth motion, thereby forming a rub track. A 4.4-pound (2.0 kg) weight was mounted on the upper end of the vertical rod. One back and forth horizontal motion of the horizontal rod constitutes a cycle.

The static contact angle was measured in the rub track as a function of the number of cycles, according to the “Contact Angle Measurement Test”. Static contact angle measurements were made every 40 cycles up to 320 cycles, then every 100 cycles. The test was terminated when the static contact angle with deionized water fell below 90°, and the total number of cycles was reported as Total Dry Rub Cycles.

Pen Test

A surface of the lens to be evaluated was marked by hand with a black permanent marking pen (available under the trade designation “SHARPIE” from Sanford Co., Bellwood, Ill.) and then wiped by hand with a dry tissue (available under the trade designation “KIMWIPE” from Kimberly Clark, Roswell, Ga.). The entire process of marking and wiping was repeated twice more. The appearance of the lens was then rated as follows: “pass” indicated that no ink residue was observed by eye on the surface of the lens; and “fail” indicated that an ink residue was observed by eye on the surface of the lens.

Preparation of Perfluoropolyether Silane PFPE1:

A perfluoropolyether obtained under the trade designation “FOMBLIN Z-DEAL” from Ausimont USA, Thorofare, N.J. (believed to have the formula CH₃OC(O)CF₂(CF₂O)ₙ(CF₂CF₂O)ₘCF₂C(O)OCH₃, wherein the number average value of both n and m are in a range of 10-12) was reacted with (3-aminopropyl)-trimethoxysilane in a respective molar ratio of 1:2 generally as described in U.S. Pat. No. 3,810,874 (see Table 1, line 6 and Column 7, line 42 to Column 8, line 50), the disclosure of which is incorporated herein by reference. Briefly, the dimethyl ester and the aminoalkoxysilane components were mixed together at room temperature, giving rise to an exothermic reaction. Progress of the reaction was determined using infrared analysis by monitoring the disappearance of the ester carbonyl absorption band at about 1790 cm⁻¹ and the appearance of the amide carbonyl absorption band at about 1715 cm⁻¹. The resulting product was designated perfluoropolyether silane PFPE1, which is believed to have the formula Q²CF₂O(CF₂O)ₐ(C₂F₄O)_{b}CF₂Q², wherein Q² is —CONH(CH₂)₃Si(OCH₃)₃, and wherein the number average value of both a and b are in a range of 10-12.

Preparation of Perfluoropolyether Silane (PFPE2)

C₃F₇O(CF(CF₃)CF₂O))ᵣCF(CF₃)C(═O)F wherein the number average value of r was approximately 5 was prepared by cesium fluoride-initiated oligomerization of hexafluoropropylene oxide in diglyme with distillative removal of low-boiling components, as generally described in U.S. Pat. No. 3,274,244 (Mackenzie) and U.S. Pat. No. 3,250,808 (Moore et al.), the disclosures of which are incorporated herein by reference.

The acyl fluoride was converted to the methyl ester by well-known esterification procedures, and then 54.1 g of the methyl ester and 8.44 g of 3-aminopropyltrimethoxysilane were combined in a screw-top vial. The mixture was shaken to give a cloudy liquid that clarified within a few minutes. It was left to stand at room temperature for one week, after which time infrared analysis showed greater than 99 percent conversion to the corresponding amide C₃F₇O(CF(CF₃)CF₂))ᵣCF(CF₃)C(═O)NH(CH₂)₃Si(OCH₃)₃ (i.e., PFPE2) wherein the number average value of r is approximately 5.

### Examples 1-6 and Comparative Examples A-I

Polycarbonate lenses having a hardcoat designated as either GLC or PDQ and further modified with an anti-reflective coating were obtained from Twin City Optical, Plymouth, Minn. The lenses were approximately 70 to 76 millimeters in diameter and 1.5 millimeters thick.

Lenses of the indicated type were cleaned by first sonicating them for two minutes in an ultrasound bath containing isopropyl alcohol, then exposing them to an air plasma using a cleaner/sterilizer (obtained under the trade designation “HARRICK PDC-3XG PLASMA CLEANER/STERILIZER” from Harrick Scientific Corporation, Ossining, N.Y.) operated at a pressure of about 0.5 torr (70 pascals) for 10 minutes.

Each lens was then immersed into a 0.1 weight percent solution of PFPE1 in methyl perfluorobutyl ether (obtained under the trade designation “3M NOVEC ENGINEERED FLUID HFE-7100” from 3M Company), followed by immediate vertical withdrawal of the lens from the fluorinated organosilane solution at the indicated rate using an automated dip coater resulting in a coated lens, which was allowed to dry for 30 to 60 minutes at room temperature.

Coated lenses were immersed into the catalyst composition s indicated in Table 1 using an automated dip coater followed by immediate withdrawal of the lens from the catalyst composition at a rate of 11 millimeters per minute. Any excess catalyst composition on the lens after removal from the catalyst composition was blown off using a stream of nitrogen.

Each lens was then left at room temperature for at least 2 hours, after which they were evaluated according to the “Pen Test” test method. Each of the lenses dipped into the catalyst composition achieved a “Pass” rating. The lenses were also evaluated for initial static contact angle and abrasion resistance as described above in the “Contact Angle Measurements” and “Dry Rub Test” test methods. The results are shown in Table 1 below.

TABLE 1

| | | Fluorinated Silane | | | | | |
|---|---|---|---|---|---|---|---|
| | | Dip Coating | | | Initial Static Contact | | |
| | Lens | withdrawal rate, | | Acid | Angle with deionized | pH of Catalyst | Total Dry |
| Example | Type | millimeters/second | Catalyst Composition | Type | water, degrees | Composition | Rub Cycles |
| Comparative | PDQ | 5 | none | NA | 110 | NA | 120 |
| Example A | | | | | | | |
| Comparative | PDQ | 11 | none | NA | NM, | NA | 120, |
| Examples | | | | | 110, | | 200, |
| B1, B2, B3 | | | | | 108 | | 720 |
| Comparative | PDQ | 15 | none | NA | 112, | NA | 280, |
| Examples | | | | | NM | | 200 |
| C1, C2 | | | | | | | |
| Comparative | GLC | 5 | none | NA | 111 | NA | 120 |
| Example D | | | | | | | |
| Comparative | GLC | 11 | none | NA | 108 | NA | 280 |
| Example E | | | | | | | |
| Comparative | PDQ | 11 | 5 weight percent | weak | 109 | NM | 160 |
| Example F | | | aqueous acetic acid | | | | |
| Comparative | PDQ | 15 | 5 weight percent | weak | 111 | NM | 240 |
| Example G | | | aqueous acetic acid | | | | |
| Comparative | PDQ | 11 | 1 molar phosphoric | weak | NM | NM | 200 |
| Example H | | | acid | | | | |
| Comparative | PDQ | 15 | 1 molar phosphoric | weak | NM | NM | 120 |
| Example I | | | acid | | | | |
| 1 | PDQ | 5 | 0.1 N aqueous HCl | strong | 114 | 1 | 520 |
| 2 | PDQ | 11 | 0.1 N aqueous HCl | strong | 114 | 1 | 620 |
| 3 | GLC | 5 | 0.1 N aqueous HCl | strong | 113 | 1 | 280 |
| 4 | GLC | 11 | 0.1 N aqueous HCl | strong | 110 | 1 | 720 |
| 5 | PDQ | 11 | 1 N p-toluenesulfonic | strong | 110 | 1 | 420 |
| | | | acid | | | | |
| 6 | PDQ | 15 | 1 N p-toluenesulfonic | strong | 109 | 1 | 420 |
| | | | acid | | | | |

### Example 7 and Comparative Examples J-K

Silicon wafers having a 10 centimeter diameter (p/boron doped, <100> orientation) were cleaned using a 5-minute exposure in a UV/ozone chamber. The UV/ozone chamber contained an ultraviolet lamp measuring 5 inches by 5 inches (12.5 cm by 12.5 cm) (obtained under the trade designation “UV GRID LAMP, model 88-9102-02” from BHK, Claremont, Calif.), which was encased in a small sheet metal box (13 cm wide x 14 cm deep x 15 cm high) such that the lamp was suspended 8 cm above the bottom of the box. A small lab jack was used to position metal wafer pieces to be cleaned as close as possible to the ultraviolet lamp without physically contacting the lamp. The front of the box was a door, hinged at the top that allowed samples to be inserted and removed. An oxygen source was attached to a small hole in one side of the box that provided oxygen to the box at a rate of approximately 1 to 5 standard liters per minute. Optical constants were obtained on the cleaned wafer according to the Coating Thickness Test.

The cleaned wafers were then cut into 4 pieces (quarters) measuring about 50 millimeters along the cut edges. Three wafer pieces were coated with a 0.1 percent by weight solution of PFPE1 in methyl perfluorobutyl ether using an automated dip coater that used an immersion followed by immediate withdrawal at 11 millimeters per second (mm/sec). After a period of about 30 to 60 minutes at room temperature, two of the perfluoropolyether silane-coated wafer pieces were exposed to an acid dip treatment in an acidic catalyst composition as reported in Table 2.

This acid treatment used the same automated dip coater as above and a withdrawal rate of 11 millimeters/second. Any excess acid solution was blown dry under a nitrogen stream. The two acid-treated pieces and the third fluorinated silane-coated (but not acid-treated) piece were then cured at 60° C. for 1 hour, after which they were allowed to cool to room temperature. The optical constants were then measured according to the Coating Thickness Test to obtain a thickness value (Initial Thickness). Next, the wafer quarters were rinsed for 1 minute with methyl perfluorobutyl ether after which the optical constants were measured again to obtain a thickness value (Final Thickness). The results are reported in Table 2 (below).

TABLE 2

| | | | | Initial | Final |
|---|---|---|---|---|---|
| | Catalyst | | pH of Catalyst | Thickness, | Thickness, |
| Example | Composition | Acid Type | Composition | nanometers | nanometers |
| Example 7 | 0.1 N aqueous | strong | 1 | 5.4 | 5.6 |
| | HCl, | | | | |
| Comparative | 5 percent by | weak | NM | 4.9 | 2.5 |
| Example J | weight aqueous | | | | |
| | acetic acid | | | | |
| Comparative | none | NA | NA | 7.2 | 2.2 |
| Example K | | | | | |

### Example 8

Example 7 was repeated with the following modifications. The withdrawal rate after the silane dip was 15 millimeters/second; the time between the silane dip and the acid dip treatment was 15 minutes; a 0.1 N solution of aqueous hydrobromic acid (HBr) was used as the acid treatment; after blowing dry under nitrogen the acid dipped samples were allowed to cure for 30 minutes at room temperature prior to rinsing with methyl perfluorobutyl ether. Results are reported in Table 3.

### Example 9

Example 7 was repeated with the following modification. A 0.1 N solution of aqueous HNO₃ was used as the acid treatment. Results are reported in Table 3 (below).

TABLE 3

| | | | | Initial | Final |
|---|---|---|---|---|---|
| | Catalyst | | pH of Catalyst | Thickness, | Thickness, |
| Example | Composition | Acid Type | Composition | nanometers | nanometers |
| 8 | 0.1 N aqueous | strong | 1 | 8.2 | 7.6 |
| | HBr | | | | |
| 9 | 0.1 N aqueous | strong | 1 | 3.8 | 3.7 |
| | HNO₃ | | | | |

### Examples 10-12 and Comparative Examples L-N

Example 7 was repeated with the following modifications. The withdrawal rate in the silane dip-coating step was 5, 11, or 20 millimeters/second. For Comparative Examples L-N, no acid dip was used. Results are reported in Table 4 (below).

TABLE 4

| | Fluorinated | | | | | |
|---|---|---|---|---|---|---|
| | Silane Dip | | | | | |
| | Coating | | | | | |
| | Withdrawal | | | | | |
| | Rate, | | | pH of | Initial | Final |
| | millimeters | Catalyst | Acid | Catalyst | Thickness, | Thickness, |
| Example | per second | Composition | Type | Composition | nanometers | nanometers |
| Comparative | 5 | none | NA | NA | 4.4 | 1.9 |
| Example L | | | | | | |
| 10 | 5 | 0.1 N | strong | 1 | 2.6 | 2.6 |
| | | aqueous | | | | |
| | | HCl | | | | |
| Comparative | 11 | none | NA | NA | 7.6 | 2.4 |
| Example M | | | | | | |
| 11 | 11 | 0.1 N | strong | 1 | 4.6 | 4.7 |
| | | aqueous | | | | |
| | | HCl | | | | |
| Comparative | 20 | none | NA | NA | 9.3 | 1.6 |
| Example N | | | | | | |
| 12 | 20 | 0.1 N | strong | 1 | 6.8 | 6.5 |
| | | aqueous | | | | |
| | | HCl | | | | |

### Examples 13-15

Example 7 was repeated with the following modifications. The withdrawal rate in the silane dip-coating step was 5, 11, or 20 millimeters/second. Optical constants were measured after the fluorinated organosilane coating, but before the catalyst composition treatment in order to determine the fluorinated organosilane coating thickness. The catalyst composition was 0.01 N aqueous HCl (pH=2). Results are reported in Table 5 (below).

TABLE 5

| | Silane | Silane | | |
|---|---|---|---|---|
| | Dip Speed, | Coating | Initial | Final |
| | millimeters/ | Thickness, | Thickness, | Thickness, |
| Example | second | nanometers | nanometers | nanometers |
| 13 | 5 | 4.2 | 2.7 | 2.5 |
| 14 | 11 | 7.0 | 4.5 | 3.6 |
| 15 | 20 | 9.1 | 7.2 | 5.0 |

### Examples 16-18

Blends of perfluoropolyether silane compounds were used to coat quarter pieces of a silicon wafer for each example. Stock solutions of 10 percent by weight PFPE1 in methyl perfluorobutyl ether and 10 percent by weight of PFPE2 in methyl perfluorobutyl ether were prepared. These were used to prepare three different solutions of a 0.1 percent by weight of a blend of PFPE1 and PFPE2 in methyl perfluorobutyl ether. The three solutions had PFPE1: PFPE2 blend ratios (on a weight to weight basis) of 75:25, 50:50; and 25:75, respectively.

Example 7 was then repeated, except using the PFPE1:PFPE2 blends prepared above in place of the 0.1 weight percent solution of PFPE1 in methyl perfluorobutyl ether; the withdrawal rate from the silane solutions was 15 millimeters/second; optical constants were measured before the acid treatment after the silane coating in order to determine the silane coating thickness; and after the acid dip treatment the wafer pieces were allowed to stand at room temperature for 1 hour before being rinsed with methyl perfluorobutyl ether. The results are reported in Table 6 (below).

TABLE 6

| | | PFPE Silane | | |
|---|---|---|---|---|
| | | Coating | Initial | Final |
| | PFPE1:PFPE2 | Thickness, | Thickness, | Thickness, |
| Example | blend ratio | nanometers | nanometers | nanometers |
| Example 16 | 75:25 | 7.6 | 6.3 | 6.1 |
| Example 17 | 50:50 | 7.6 | 6.1 | 5.6 |
| Example 18 | 25:75 | 7.4 | 3.9 | 3.4 |

Various modifications and alterations of this invention may be made by those skilled in the art without departing from the scope and spirit of this invention, and it should be understood that this invention is not to be unduly limited to the illustrative embodiments set forth herein.

1. A method for coating a substrate comprising:
coating at least a portion of a substrate with a precursor composition to form a coated substrate, wherein the precursor composition comprises a liquid vehicle and at least one fluorinated organosilane having the formula
R_{f}O—W—R³-Q
or
Q-R³—OW—R³-Q
wherein
W represents a divalent perfluoropolyether segment comprising at least 5 monomer units selected from the group consisting of —CF₂O—, —CF₂CF₂O—, —CF(CF₃)CF₂O—, —OCF(CF₃)CF₂—, —CF₂CF₂CF₂—, —CF₂CF₂CF₂CF₂O—, and combinations thereof;
R_{f} is a perfluoroalkyl group having from 1 to 8 carbon atoms;
Q independently represents -Z-R¹—SiY₍₃₋ₓ₎R²ₓ;
wherein
Z independently represents a covalent bond, a carbonyloxy group, a carbonylthio group, a carbonylamino group, an alkyleneoxycarbonyl group having from 2 to 7 carbon atoms, an alkylenaminocarbonyl group having from 2 to 7 carbon atoms, an alkyleneoxycarbonylamino group having from 2 to 7 carbon atoms, an alkylenoxy group having from 1 to 6 carbon atoms, or an alkyleneaminocarbonyloxy group having from 2 to 7 carbon atoms;
R¹ independently represents a divalent linear or branched alkylene or alkylenoxyalkylene group having from 1 to 6 carbon atoms;
R² independently represents an alkyl group having from 1 to 4 carbon atoms;
Y independently represents halogen, an alkoxy group having from 1 to 4 carbon atoms, or an acyloxy group having from 1 to 4 carbon atoms;
x independently represents 0 or 1; and
R³ independently represents —CF₂—, —CF(CF₃)—, —CF₂CF₂—, or —CF₂CF₂CF₂—; and
contacting at least a portion of the coated substrate with a catalyst composition comprising at least one strong acid and having a pH of less than or equal to 3 to provide a substrate having a crosslinked fluoropolymeric coating on at least a portion thereof, wherein the substrate comprises an ophthalmic lens having an antireflective coating on at least a portion thereof.

2. (canceled)

3. The method of claim 1, further comprising at least partially removing the liquid vehicle.

4. The method of claim 1, wherein coating comprises dip coating.

5. The method of claim 4, wherein dip coating includes dipping the substrate into the precursor composition and then removing it at a rate of greater than 10 millimeters per minute.

6. The method of claim 4, wherein dip coating includes dipping the substrate into the precursor composition and then removing it at a rate of greater than 20 millimeters per minute.

7. The method of claim 1, wherein W has the formula
—(CF₂O)ₘ(CF₂CF₂O)ₙ—
wherein
m is an integer in a range of from 8 to 11; and
n is an integer in a range of from 8 to 11.

8. The method of claim 1, wherein W has the formula
—(CF(CF₃)CF₂O)ₖ—
wherein k is an integer in a range of from 5 to 10.

9. The method of claim 1, wherein the substrate comprises at least one thermoplastic organic polymer.

10. The method of claim 9, wherein the thermoplastic organic polymer comprises polycarbonate.

11. The method of claim 1, wherein the at least one strong acid has a pKₐ in water at 25° C. of less than or equal to that of nitric acid.

12. The method of claim 1, wherein the at least one strong acid comprises at least one of hydrochloric acid, hydrobromic acid, sulfuric acid, hydriodic acid, perchloric acid, nitric acid, methanesulfonic acid, para-toluenesulfonic acid, trifluoromethanesulfonic acid, or a combination thereof.

13. The method of claim 1, wherein the at least one strong acid comprises at least one of hydrochloric acid, hydrobromic acid, or a combination thereof.

14. The method of claim 1, wherein the at least one strong acid comprises hydrochloric acid.

15. The method of claim 1, further comprising cleaning the substrate.

16. The method of claim 1, further comprising rinsing the substrate having a crosslinked fluoropolymeric coating on at least a portion thereof.

17. The method of claim 1, further comprising heating at least one of the substrate) the coated substrate, or the substrate having a crosslinked fluoropolymeric coating on at least a portion thereof.

18. The method of claim 12, wherein the substrate comprises an eyeglass lens.

19. (canceled)

20. The method of claim 18, further comprising mounting the eyeglass lens in an eyeglass frame.
